(19) United States
(12) Patent Application Publication
(10) Pub. No.: US 2018/0157402 A1
(43) Pub. Date: Jun. 7, 2018

(54) METHOD AND SYSTEM FOR SYNCHRONOUSLY MANIPULATING INTERDEPENDENT MEDICAL DEVICE OPERATING PARAMETERS ON A TOUCHSCREEN DEVICE

(71) Applicant: General Electric Company, Schenectady, NY (US)

(72) Inventors: Heinz Schmied, Zipf (AT); Helmut Brandl, Zipf (AT)

(21) Appl. No.: 15/366,672

(22) Filed: Dec. 1, 2016

(51) Int. Cl. G06F 3/0484; G06F 3/0482; G06F 3/0488

(52) U.S. Cl. CPC G06F 3/04847; G06F 3/0482; G06T 1/0007; G06T 2210/41; G06F 3/0488

(57) ABSTRACT

A system and method for facilitating synchronous manipulation of interdependent medical device operating parameters is provided. The method includes displaying medical image data as it is acquired. The medical image data is acquired based on operating parameters each having an associated value. The method includes receiving a selection to adjust the associated value of one of the operating parameters. The selected one of the operating parameters is a parameter in a pre-defined set of operating parameters. The method includes presenting an operating parameter user interface including the pre-defined set of operating parameters. The method includes receiving a touch user input that synchronously sets the associated value of each of a plurality of the operating parameters in the pre-defined set. The method includes instantaneously updating the displayed medical image data as the associated value of each of the operating parameters in the pre-defined set is synchronously set.

### CROSS-REFERENCE TO RELATED APPLICATIONS/INCORPORATION BY REFERENCE

[Not Applicable]

### FIELD

Certain embodiments of the disclosure relate to medical device operating parameters. More specifically, certain embodiments of the disclosure relate to a method and system for enhanced visualization and manipulation of medical device operating parameters that influence image quality by providing a touchscreen device that facilitates synchronous manipulation of interdependent medical device operating parameters.

### BACKGROUND

Medical devices, such as ultrasound, magnetic resonance imaging (MRI), computed tomography (CT), digital radiography, and/or X-ray imaging modalities, operate according to various parameters, many of which are user-definable. The operating parameters may include associated values defining how medical image data is acquired and/or how the acquired medical image data is processed. Accordingly, the selected values for the various medical device operating parameters may influence the image quality of the acquired and displayed medical image data. For example, values corresponding with image brightness and image contrast may be adjusted by a medical device operator during a scan to enhance the quality of the acquired medical image data.

In some cases, adjustments to a first operating parameter value may necessitate changes in other medical device operating parameters in order to achieve a desired quality of the displayed medical image data. For example, a dynamic contrast operating parameter value may be increased to enhance the visibility of edges of structures shown in the medical image data and an operator may also reduce a gain operating parameter value in response to the dynamic contrast operating parameter adjustment to maintain the overall image brightness. As another example, an ultrasound operator that desires to maintain a frame rate may decrease a pulse repetition frequency operating parameter value when increasing a color flow quality operating parameter to decrease signal noise. Another ultrasound example includes the interdependent compound resolution imaging (CRI) level, frame filter, and line filter operating parameters. Specifically, an ultrasound operator may increase the CRI level operating parameter to provide additional contrast while decreasing the frame filter operating parameter value to decrease blurriness caused by motion in the ultrasound image data. Moreover, an ultrasound operator may increase a line filter operating parameter value to reduce image noise while increasing a CRI level operating parameter value to maintain the image resolution.

Typical medical imaging systems include user interfaces for adjusting operating parameter values. FIG. 1 illustrates an exemplary medical device user interface 10 as known in the art. The medical device user interface 10 may illustrate various operating parameters 12. Moreover, the medical user interface 10 may include mechanisms 14, 16 for adjusting the operating parameter level. Referring to FIG. 1, the medical device user interface 10 illustrates, among other things, a CRI level 12 set to a value of 2. An operator of the medical device user interface 10 may, for example, increase the CRI level 12 by selecting an increase button 14 and/or may decrease the CRI level 12 by selecting a decrease button 16. As noted above, an ultrasound operator may want to adjust other interdependent operating parameter values, such as a frame filter and a line filter, when adjusting a CRI level 12. FIG. 2 illustrates an exemplary secondary page 20 of the exemplary medical device user interface 10 shown in FIG. 1 as known in the art. Referring to FIG. 2, the secondary page 20 illustrates, among other things, a frame filter 21 set to a value of 3 and a line filter 24 set to a low value. An operator of the secondary page 20 may, for example, increase the frame filter value 21 and/or line filter value 24 by selecting an increase button 22, 25. The operator may additionally and/or alternatively decrease the frame filter value 21 and/or line filter value 24 by selecting a decrease button 23, 26.

Existing medical imaging systems may separately receive user inputs adjusting different operating parameters. In some cases, the operating parameters may be accessed at different user interface pages as described above with reference to FIGS. 1 and 2. Accordingly, navigating a user interface to different operating parameters may be cumbersome. Moreover, separately adjusting multiple operating parameters can be time consuming.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method is provided for enhancing visualization and manipulation of medical device operating parameters that influence image quality by providing a touchscreen device that facilitates synchronous manipulation of interdependent medical device operating parameters, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary medical device user interface as known in the art.

FIG. 2 illustrates an exemplary secondary page of the exemplary medical device user interface shown in FIG. 1, as known in the art

FIG. 3 is a block diagram of an exemplary medical imaging system having interdependent medical device operating parameters that may be simultaneously manipulated to influence image quality, in accordance with an embodiment of the disclosure.

FIG. 4 illustrates an exemplary operating parameter user interface configured to receive a user input to synchronously manipulate two interdependent medical device operating parameters, in accordance with an embodiment of the disclosure.

FIG. 5 illustrates an exemplary operating parameter user interface receiving a user input to synchronously manipulate two interdependent medical device operating parameters, in accordance with an embodiment of the disclosure.

FIG. 6 illustrates an exemplary operating parameter user interface configured to receive a user input to synchronously manipulate three interdependent medical device operating parameters, in accordance with an embodiment of the disclosure.

FIG. 7 illustrates an exemplary operating parameter user interface receiving a user input to synchronously manipulate three interdependent medical device operating parameters, in accordance with an embodiment of the disclosure.

FIG. 8 illustrates an exemplary operating parameter user interface configured to receive a user input to manipulate a first medical device operating parameter that automatically adjusts a second medical device operating parameter, in accordance with an embodiment of the disclosure.

FIG. 9 illustrates an exemplary operating parameter user interface receiving a user input to manipulate a first medical device operating parameter that automatically adjusts a second medical device operating parameter, in accordance with an embodiment of the disclosure.

FIG. 10 is a flow chart illustrating exemplary steps that may be utilized for simultaneously manipulating interdependent medical device operating parameters to influence image quality, in accordance with an embodiment of the disclosure.

### DETAILED DESCRIPTION

Certain embodiments of the disclosure may be found in a method and system for manipulating medical device operating parameters. More specifically, aspects of the present disclosure have the technical effect of providing a touchscreen user interface that facilitates the simultaneous setting of values for a plurality of interdependent operating parameters. Various embodiments have the technical effect of improving the visualization of interdependent medical device operating parameter value adjustments by displaying updated medical image data substantially in real-time as the values of the medical device operating parameters are synchronously changed.

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized and that structural, logical and electrical changes may be made without departing from the scope of the various embodiments of the present disclosure. The following detailed description is, therefore, not to be taken in a limiting sense, and the scope of the present disclosure is defined by the appended claims and their equivalents.

As used herein, an element or step recited in the singular and proceeded with the word “a” or “an” should be understood as not excluding plural of said elements or steps, unless such exclusion is explicitly stated. Furthermore, references to “an embodiment,” “one embodiment,” “a representative embodiment,” “an exemplary embodiment,” “various embodiments,” “certain embodiments,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

Furthermore, the term processor or processing unit, as used herein, refers to any type of processing unit that can carry out the calculations performed in various embodiments, such as single or multi-core: CPU, Graphics Board, DSP, FPGA, ASIC or a combination thereof.

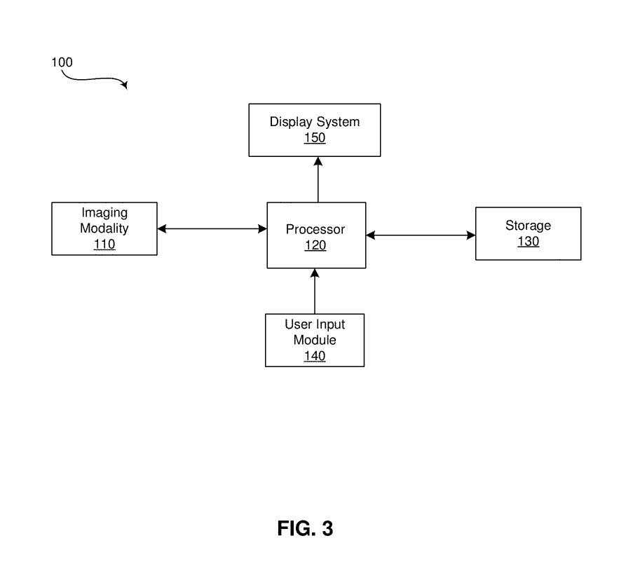

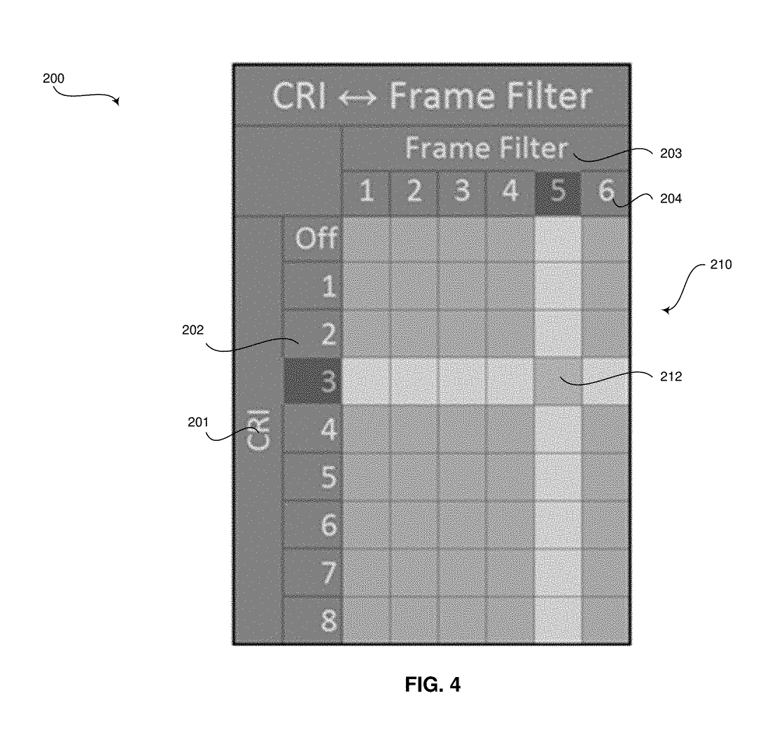

It should be noted that various embodiments are described herein with reference to operating parameters of imaging modalities. For example, FIG. 3 illustrates an exemplary medical imaging system and FIGS. 4-9 illustrate screenshots from an exemplary touchscreen user interface configured to receive a touch user input to synchronously manipulate interdependent medical device operating parameters. Although various examples may be provided directed to particular imaging modalities such as an ultrasound system, aspects of the present disclosure are not limited to ultrasound system imaging modalities. Instead, any suitable imaging modality, such as ultrasound, magnetic resonance imaging (MRI), computed tomography (CT), digital radiography, X-ray, and the like is contemplated.

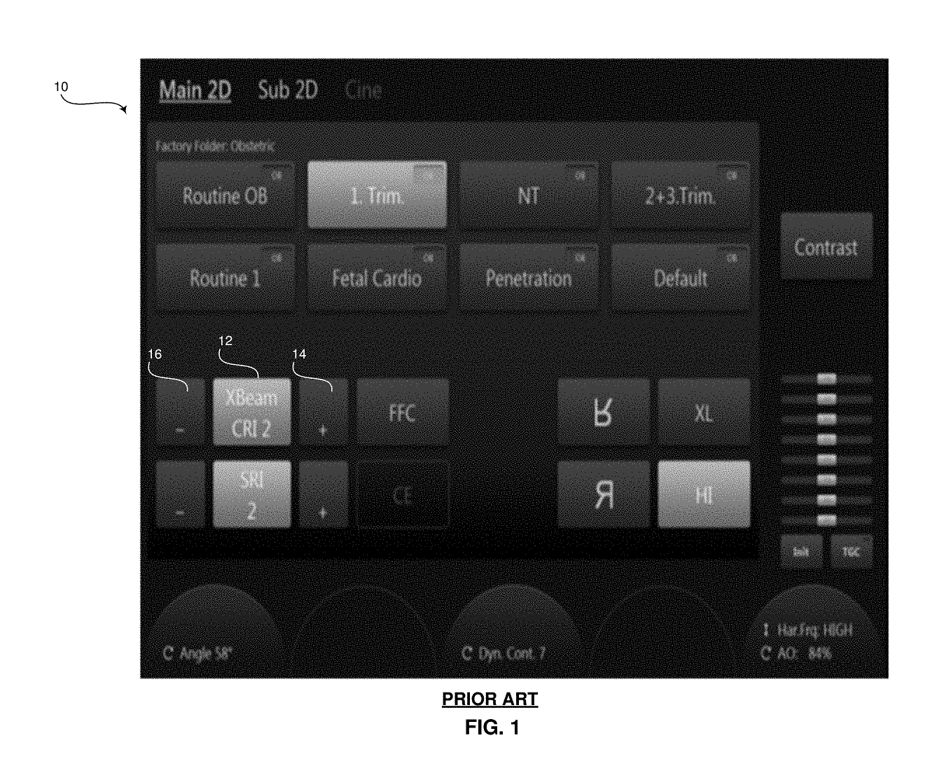

FIG. 3 is a block diagram of an exemplary medical imaging system 100 having interdependent medical device operating parameters that may be simultaneously manipulated to influence image quality, in accordance with an embodiment of the disclosure. The system 100 includes an imaging modality 110, a processor 120, storage 130, a user input module 140, and a display system 150. The system 100 may include any number of imaging modalities 110, processors 120, storage components 130, user input modules 140, and display systems 150 and is not in any way limited to the embodiment of system 100 illustrated in FIG. 1. The components of the system 100 may communicate via wired and/or wireless communication, for example, and may be separate systems and/or integrated to varying degrees, for example.

The imaging modality 110 comprises suitable logic, circuitry, interfaces and/or code that may be operable to capture an image of a patient anatomy. For example, the imaging modality 110 may include an ultrasound scanner, magnetic resonance imager, X-ray imager, or the like. The imaging modality 110 acquires image data in response to operating parameters and instructions communicated by processor 120 to the imaging modality 110. The image data representative of acquired image(s) is communicated from the imaging modality 110 to the processor 120. The operating parameters, instructions, and image data may be communicated electronically over a wired or wireless connection, for example.

The storage 130 comprises suitable logic, circuitry, interfaces and/or code that may be operable to store medical device operating parameters, image data, and any other suitable information. The storage 130 may be one or more computer-readable memories, for example, such as a hard disk, floppy disk, CD, CD-ROM, DVD, compact storage, flash memory, random access memory, read-only memory, electrically erasable and programmable read-only memory and/or any suitable memory. The storage 130 may include databases, libraries, sets of information, or other storage accessed by and/or incorporated with the processor 120, for example. The storage 130 may be able to store data temporarily or permanently, for example. In various embodiments, the storage 130 stores one or more software applications. In a representative embodiment, the storage 130 may store operating parameter values and associations of interdependent operating parameters.

The user input module 140 comprises suitable logic, circuitry, interfaces and/or code that may be operable to communicate information from a user and/or at the direction of the user to the processor 120 of the system 100, for example. The user input module 140 may include button(s), a touchscreen, motion tracking, voice recognition, a mousing device, keyboard, camera and/or any other device capable of receiving a user directive. In certain embodiments, one or more of the user input modules 140 may be integrated into other components, such as the display system 150, for example. As an example, user input module 140 may include a touchscreen display such as a touchscreen display with multi-touch functionality. In various embodiments, the user input module 140 may provide medical device operating parameter values for an imaging modality 110 or other medical device to processor 120. The operating parameters may be used to operate the imaging modality 110 to acquire image data and/or process image data acquired by the imaging modality 110, for example.

The display system 150 comprises suitable logic, circuitry, interfaces and/or code that may be operable to communicate visual information to a user. For example, a display system 150 may include one or more monitors comprising a liquid crystal display, a light emitting diode display, and/or any suitable display. The display system 150 can be integrated with the user input module 140 to form a touchscreen display operable to display an operating parameter user interface that facilitates synchronous manipulation of interdependent medical device operating parameters as discussed below with reference to FIGS. 4-9. The display system 150 may be operable to display image data acquired by imaging modality 110 and processed by processor 120, for example.

The processor 120 comprises suitable logic, circuitry, interfaces and/or code that may be operable to control the imaging modality 110 based at least in part on operating parameters and process image data acquired by imaging modality 110 for generating an image for presentation on the display system 150. The processor 120 may be one or more central processing units, microprocessors, microcontrollers, and/or the like. The processor 120 may be an integrated component, or may be distributed across various locations, for example. The processor 120 may be capable of executing any of the method(s) 300 and/or set(s) of instructions discussed below in accordance with the present disclosure, for example.

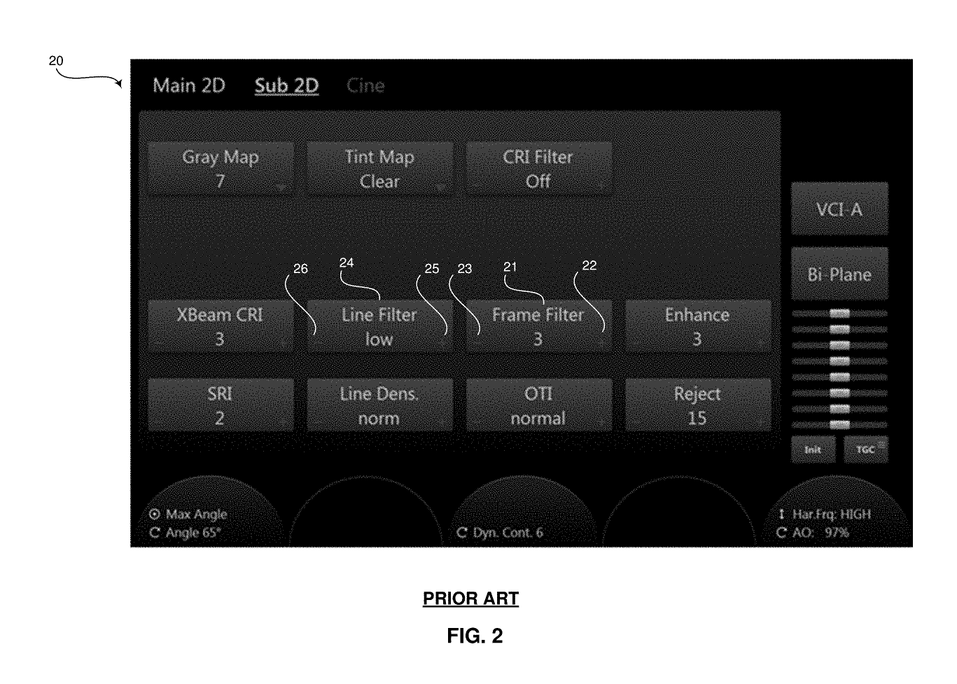

In operation, a user may launch an operating parameter user interface by selecting for adjustment an operating parameter that is a parameter in a pre-defined interdependent set of operating parameters. For example, referring to FIGS. 1 and 2, the compound resolution imaging (CRI) level 12, frame filter 21, and line filter 24 operating parameters may form a set of interdependent operating parameters. A user selection of one of the operating parameters 12, 21, 24 may launch an operating parameter user interface configured to facilitate the simultaneous setting of values for the operating parameters 12, 21, 24 as described below with reference to FIGS. 4-9. Referring again to FIG. 3, the processor 120 may receive a synchronous selection of values corresponding with the operating parameters 12, 21, 24. For example, a touch input such as a sliding user finger and/or a multi-touch input such as sliding user fingers may be received at a surface of a touchscreen user input module 140 and processed by the processor 120 to simultaneously select or modify values of the operating parameters 12, 21, 24. In response to the selected values, the processor 120 may store the values in storage 130 and may instantaneously apply the selected operating parameter values to an ongoing medical image acquisition at the imaging modality 110 or other medical device such that medical image data presented at the display system 150 is updated in substantially real-time. In this way, the user may visualize the effect of the operating parameter value adjustments as the touch input(s) slides across the surface of the touchscreen user input module 140. The user may continue to synchronously adjust the operating parameter values 12, 21, 24 as medical image data is being acquired by the imaging modality 110 based on the visual feedback from the medical image data updating in substantially real-time at the display system 150.

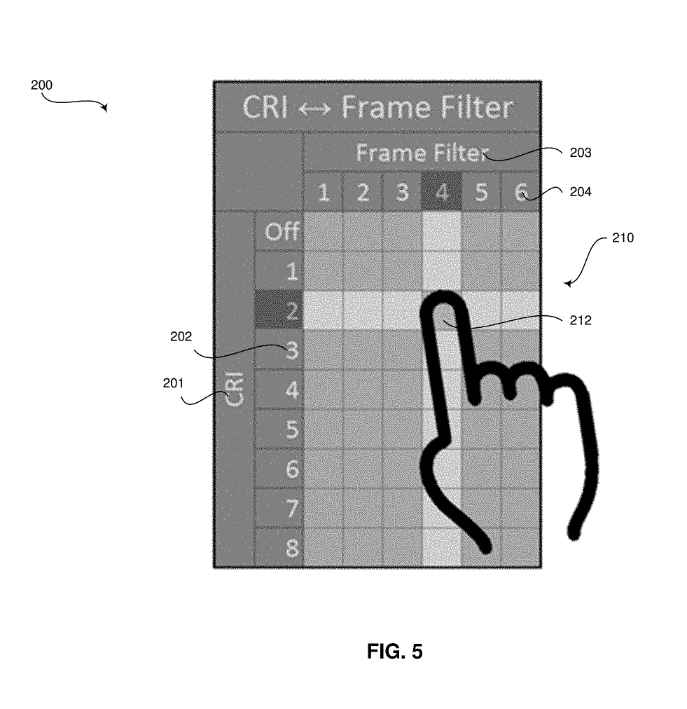

FIG. 4 illustrates an exemplary operating parameter user interface 200 configured to receive a user input to synchronously manipulate two interdependent medical device operating parameters 201, 203, in accordance with an embodiment of the disclosure. FIG. 5 illustrates an exemplary operating parameter user interface 200 receiving a user input to synchronously manipulate two interdependent medical device operating parameters 201, 203. Referring to FIGS. 4 and 5, an exemplary operating parameter user interface 200 is shown. The operating parameter user interface 200 may be presented at a touchscreen user input module 140. The operating parameter user interface 200 may comprise multiple operating parameters 201, 203 having corresponding values 202, 204 and an indication 212 of the current selected values. For example, the operating parameters may include compound resolution imaging (CRI) level 201 and a frame filter setting 203, or any suitable operating parameters. The CRI level 201 may comprise values 202 of “off” and 1 through 8. The frame filter setting 203 may include values of 1 through 6. The values 202, 204 of the multiple operating parameters 201, 203 may be presented in a grid 210 with the indication 212 of the current selected values being a highlighted point within the grid 210.

Referring to FIG. 4, a CRI level 201 may be a value 202 set to 3 and a frame filter setting 203 can be a value 204 set to 5, for example. The current selected value indicator 212 may be the point in the grid 210 that the current selected values 202, 204 of each of the operating parameters 201, 203 intersect. Referring to FIG. 5, the operating parameter user interface 200 may receive a touch input at the touchscreen user input module 140 to adjust the current selected values 202, 204 of each of the operating parameters 201, 203. For example, the CRI level 201 may be adjusted from a value 202 of 3 in FIG. 4 to a value 202 of 2 in FIG. 5. The frame filter setting 203 can simultaneously be adjusted with the CRI level 201 from a value 204 of 5 in FIG. 4 to a value 204 of 4 in FIG. 5. The current selected value indicator 212 may shift as the touch input is slid or otherwise moved about the touchscreen user input module 140 corresponding with positions on the grid 210 of the operating parameter user interface 200. In various embodiments, a medical image presented at a display system 150 may instantaneously update as the two interdependent medical device operating parameters 201, 203 are synchronously manipulated in the operating parameter user interface 200.

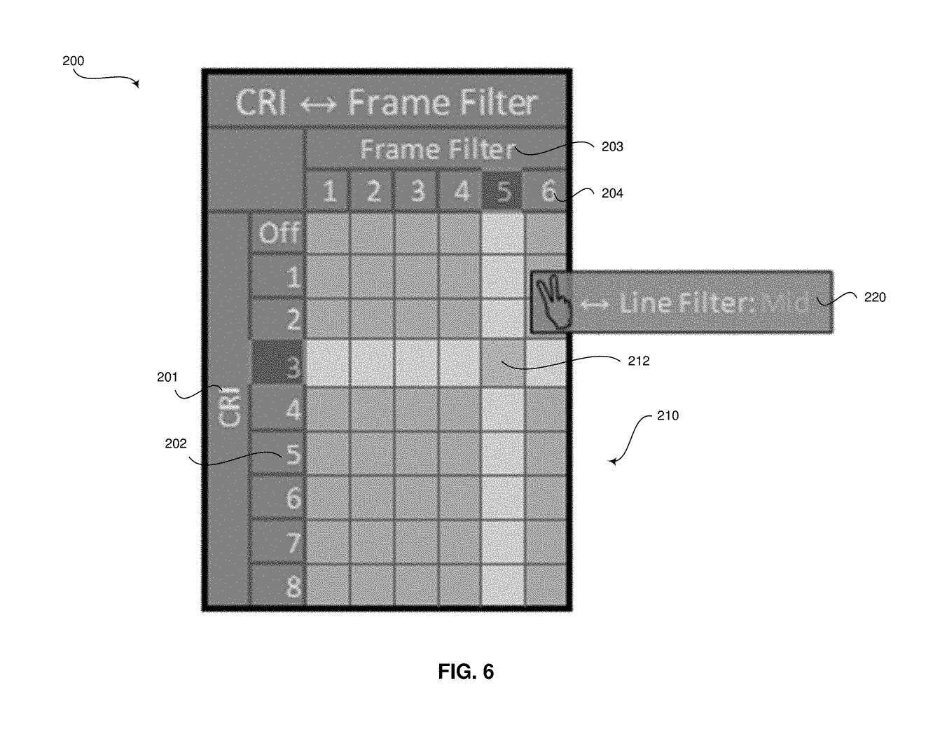

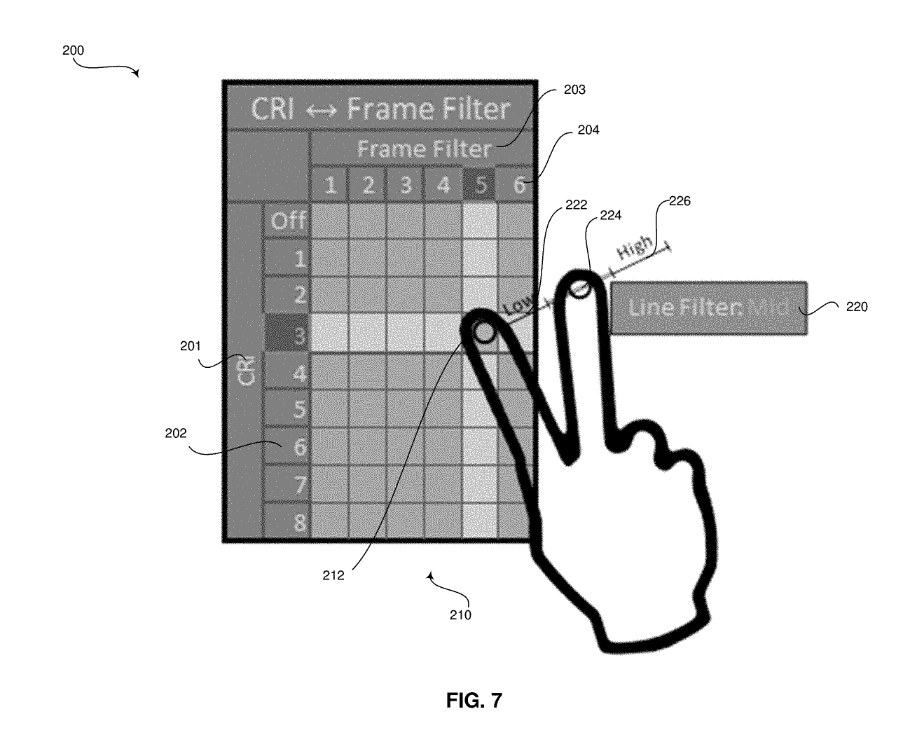

FIG. 6 illustrates an exemplary operating parameter user interface 200 configured to receive a user input to synchronously manipulate three interdependent medical device operating parameters 201, 203, 220, in accordance with an embodiment of the disclosure. FIG. 7 illustrates an exemplary operating parameter user interface 200 receiving a user input to synchronously manipulate three interdependent medical device operating parameters 201, 203, 220. Referring to FIGS. 6 and 7, the operating parameter user interface 200 comprises multiple operating parameters 201, 203, 220 each having associated values 202, 204, 222-226. The exemplary operating parameters 201, 203, 220 of FIGS. 6 and 7 include a CRI level 201, a frame filter setting 203, and a line filter setting 220. The values 202 corresponding with the CRI level 201 include “off” and 1 through 8. The values 204 corresponding with the frame filter setting 203 include 1 through 6. The values 222, 224, 226 for the line filter setting 220 include low 222, mid 224, and high 226. Still referring to FIGS. 6 and 7, the current value 202 of the CRI level 201 is 3. The current value 204 of the frame filter setting 203 is 5. The current value 224 of the line filter 220 is mid. Although FIGS. 6 and 7 illustrate various operating parameters having certain ranges, any suitable operating parameter and/or any suitable value range is contemplated.

The operating parameter user interface 200 may comprise a grid 210 having an indication 212 of at least a portion of the current selected values being presented as a highlighted point within the grid 210. For example, the current selected value indicator 212 may be the point in the grid 210 where a plurality of the current selected values 202, 204 of the operating parameters 201, 203 intersect. The operating parameter user interface 200 may be presented at a touchscreen user input module 140 configured to receive multi-touch inputs. For example, the operating parameter user interface 200 may receive a multi-touch input, such as from two or more user input mechanisms (e.g., fingers, stylus, etc.). The first touch input at the touchscreen user input module 140 may adjust the current selected values 202, 204 of two of the operating parameters 201, 203, for example, as described above with reference to FIGS. 4 and 5.

In certain embodiments, additional touch inputs received simultaneously with the first touch input at the touchscreen user input module 140 may adjust additional operating parameter(s) 220. As an example, a user may slide a second touch input of the multi-touch input across the surface of the touchscreen user input module 140. The direction and/or the distance that the input is moved may correspond to a setting value 222-226 associated with the operating parameter 220. For example, referring to FIG. 7, moving the second finger of the multi-touch input in a first direction may increase the setting value from mid 224 to high 226 and moving in a second direction may decrease the setting value from mid 224 to low 222. Although FIG. 7 illustrates the simultaneous adjustment of three operating parameters, synchronous manipulation of additional operating parameters is contemplated by, for example, adding touch inputs (e.g., fingers) and/or defining operating parameters corresponding with different touch input sliding directions (e.g., left and right, up and down, etc.). In various embodiments, medical image data being acquired and presented at a display system 150 during an examination may update in substantially real-time as the three interdependent medical device operating parameters 201, 203, 220 are synchronously manipulated in the operating parameter user interface 200 by the multi-touch input.

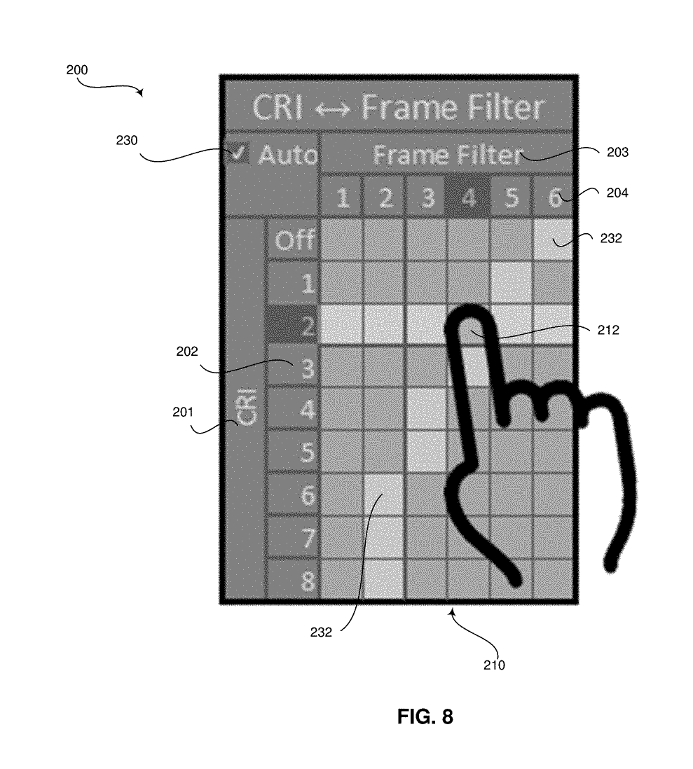

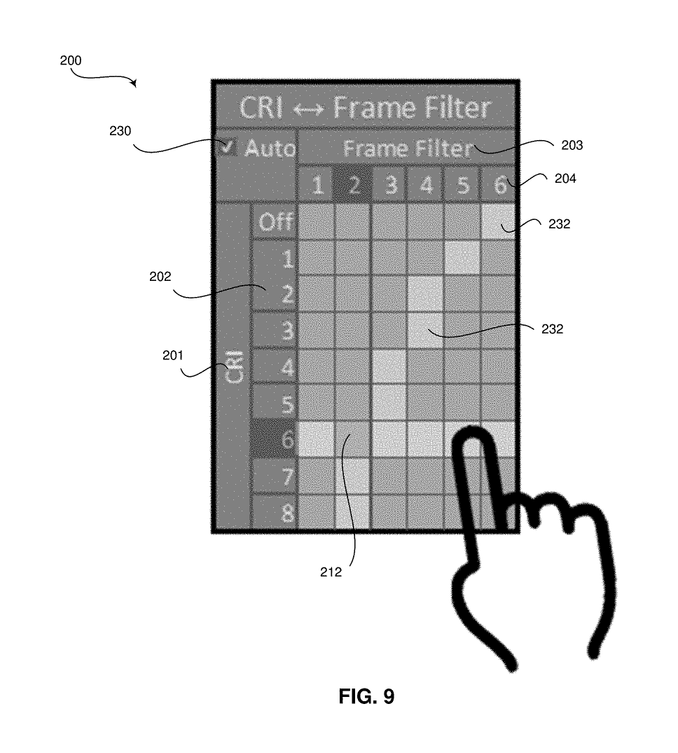

FIG. 8 illustrates an exemplary operating parameter user interface 200 configured to receive a user input to manipulate a first medical device operating parameter 201 that automatically adjusts a second medical device operating parameter 203, in accordance with an embodiment of the disclosure. FIG. 9 illustrates an exemplary operating parameter user interface 200 receiving a user input to manipulate a first medical device operating parameter 201 that automatically adjusts a second medical device operating parameter 203. Referring to FIGS. 8 and 9, an operating parameter user interface 200 may comprise operating parameters 201, 203 having associated values 202, 204 presented in a grid 210 and an indicator 212 highlighting a position in the grid 210 corresponding with currently selected values 202, 204 of the operating parameters 201, 203.

In various embodiments, the operating parameter user interface 200 may include a mechanism 230 configured to activate an automatic selection mode for automatically adjusting a second medical device operating parameter 203 in response to the manipulation of a first operating parameter 201. For example, the mechanism 230 may be a button, switch, check box, or any suitable mechanism for turning on and off the automatic selection mode. The operating parameter user interface 200 may be configured to receive a touch input to manipulate a first operating parameter 201. In response to the touch input adjusting the first operating parameter 201, a second operating parameter 203 may simultaneously be adjusted based on the modification of the first operating parameter 201 if the automatic selection mode 230 is activated.

In certain embodiments, the automatic selection values of the second operating parameter 203 may be highlighted 232 in the grid 210 of the user interface 200. For example, the frame filter setting 203 may be a value 204 of 2 as shown by highlighting 232 when the automatic selection mode 230 is activated and the CRI level 201 is manipulated to a touch input to a value 202 of 6, 7, or 8. As another example, the frame filter setting 203 may be a value of 6 as shown by the highlighting 232 when the CRI level 201 is adjusted to a value of “off.”

In operation, an operating parameter user interface 200 may receive an input activating an automatic selection mode 230. As shown in FIG. 8, the value 202 of the CRI level 201 may be set to 2 and the value 204 of the frame filter setting 203 may be 4 as illustrated by the current selected value indicator 212 in the grid 210. The user interface 200 may receive a touch input at a surface of a touchscreen user input module 140 to manipulate a value 202 of the CRI level 201 to 6 as shown in FIG. 9. In response to the manipulation of the CRI level value 202, the frame filter setting 203 may synchronously adjust to the predefined frame filter value 204 of 2 that corresponds with the selected CRI level value 202 of 6, as illustrated by the current selected value indicator 212 in the grid 210. The simultaneous adjustments of the operating parameters 201, 203 may be instantaneously applied to a medical image data acquisition such that medical image data presented at a display system 150 is updated in substantially real-time in response to the touch input at the operating parameter user interface 200 via the touchscreen user input module 140.

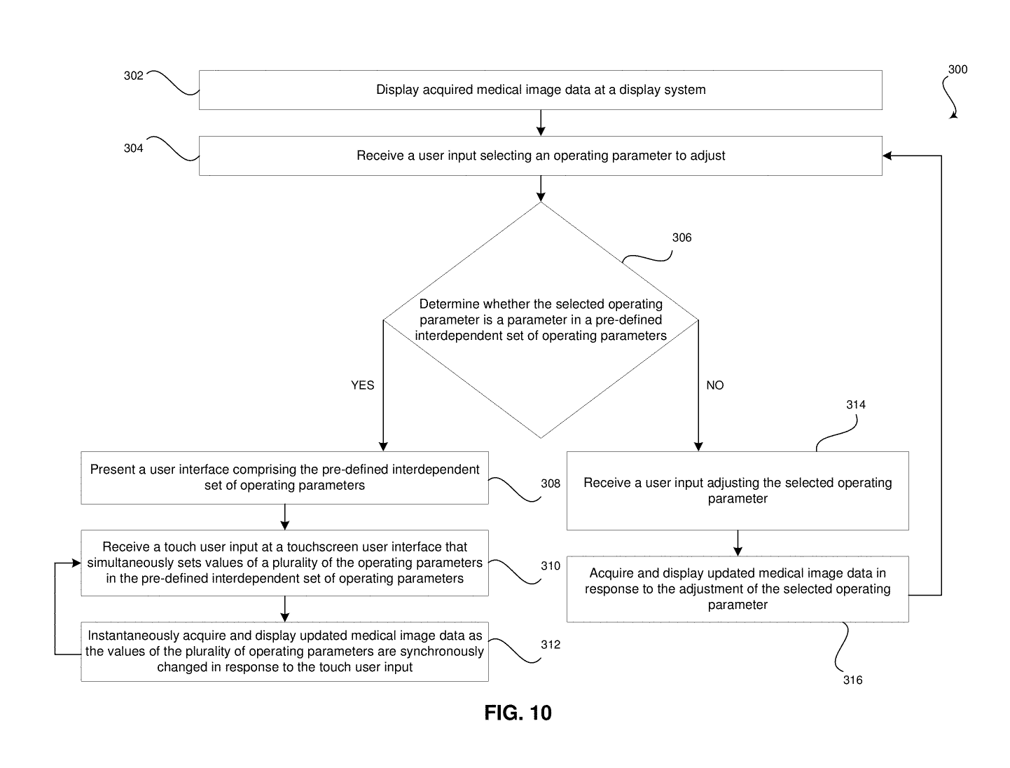

FIG. 10 is a flow chart 300 illustrating exemplary steps 302-316 that may be utilized to simultaneously manipulate interdependent medical device operating parameters 12, 21, 24, 201, 203, 220 to influence image quality, in accordance with an embodiment of the disclosure. Referring to FIG. 10, there is shown a flow chart 300 comprising exemplary steps 302 through 316. Certain embodiments of the present disclosure may omit one or more of the steps, and/or perform the steps in a different order than the order listed, and/or combine certain of the steps discussed below. For example, some steps may not be performed in certain embodiments of the present disclosure. As a further example, certain steps may be performed in a different temporal order, including simultaneously, than listed below.

At step 302, medical image data may be presented at a display system 150. For example, a medical imaging modality 110 may acquire medical image data in response to operating parameters 12, 21, 24, 201, 203, 220 and instructions communicated by processor 120 to the imaging modality 110. The medical image data representative of acquired image(s) is communicated from the imaging modality 110 to the processor 120. The processor 120 may control the medical imaging modality 110 based at least in part on the operating parameters 12, 21, 24, 201, 203, 220 and may process the medical image data acquired by the imaging modality 110 to generate medical images for presentation at the display system 150. In various embodiments, the medical imaging modality 110 may continuously acquire medical image data that is processed by the processor 120 and presented at the display system 150 during an examination.

At step 304, the processor 120 may receive a user selection of an operating parameter 12, 21, 24 to adjust via a user input module 140. For example, as medical image data is acquired by an imaging modality 110 and presented at the display system 150 during an examination, an operator may desire to change a particular quality of the displayed medical image data. The operator may navigate a medical device user interface 10, 20 to identify and select an operating parameter 12, 21, 24 to manipulate.

At step 306, the processor 120 may determine whether the selected operating parameter is a parameter in a pre-defined interdependent set of operating parameters 12, 21, 24. For example, interdependent operating parameters may have predetermined associations. In an ultrasound imaging context, for example, CRI level 12, frame filter setting 21, and/or line filter setting 24 may form a set of interdependent operating parameters. Some other examples of sets of interdependent operating parameters that may have pre-defined associations include: (1) color flow quality and pulse repetition frequency, (2) gain and dynamic contrast, (3) brightness and contrast, and/or any suitable set of interdependent operating parameters. The processor 120 may apply association rules stored in storage 130, for example, to determine whether the selected parameter is part of a set of interdependent operating parameters 12, 21, 24.

At step 308, if the selected operating parameter is in a pre-defined interdependent set of operating parameters 12, 21, 24, the processor 120 may present an operating parameter user interface 200 at a touchscreen user input module 140 to facilitate the synchronous manipulation of values associated with the interdependent set of operating parameters 12, 21, 24. The user interface 200 may comprise the pre-defined interdependent set of operating parameters 201, 203, 220 each having values 202, 204, 222-226 that may be simultaneously adjusted, for example, as described above with reference to FIGS. 4-9.

At step 310, the processor 120 may receive a touch user input via the operating parameter user interface 200 presented at the touchscreen user input module 140. The touch user input may simultaneously set values 202, 204, 222-226 of a plurality of operating parameters 201, 203, 220. For example, an operator may synchronously set operating parameter values 202, 204, 222-226 by placing and/or moving touch input(s), such as finger(s) or a stylus, on and/or across the operating parameter user interface 200 via a surface of the touchscreen user input module 140. The placement of the touch input(s) in the operating parameter user interface 200 may correspond with values of multiple operating parameters 201, 203, 220 such that the values 202, 204, 222-226 corresponding with the parameters 201, 203, 220 may be simultaneously manipulated. In various embodiments, the touch user input may include one point of contact made on the surface of the touchscreen user input module 140 that controls the manipulation of a plurality of operating parameter value 202, 204. Additionally and/or alternatively, the touch user input may include multiple points of contact made on the surface of the touchscreen user input module 140 simultaneously and each of the contact points may control the manipulation of at least one operating parameter value 202, 204, 222-226.

At step 312, the processor 120 may control the imaging modality 110 and display system 150 to instantaneously acquire and display updated medical image data as the values 202, 204, 222-226 of the operating parameters 202, 204, 220 are synchronously changed in response to the touch user input received at step 310. For example, an operator may visualize the effect of the operating parameter value 202, 204, 222-226 adjustments as the touch input(s) provided by the user slides across the surface of the touchscreen user input module 140. The process may return to step 310 such that the values 202, 204, 222-226 of the operating parameters 202, 204, 220 may continue to be simultaneously manipulated as medical image data is being acquired by the imaging modality 110 based on the visual feedback presented to the operator from the medical image data updating in substantially real-time at the display system 150.

At step 314, if the processor 120 determines at step 306 that the selected operating parameter is not in a pre-defined interdependent set of operating parameters 12, 21, 24, the processor 120 may receive via the user input module 140 an adjusted operating parameter value corresponding to the operating parameter selected at step 304. For example, as discussed above with regard to FIGS. 1 and 2, an operating parameter may be adjusted by selecting increase or decrease buttons associated with a particular operating parameter, among other things.

At step 316, the processor 120 may update the stored operating parameter value and apply the operating parameter value to acquire medical image data via the imaging modality 110 according to the updated operating parameter value. The acquired medical image data may be processed by the processor 120 and presented at a display system 150.

Aspects of the present disclosure provide a system 100 and method 300 for enhancing visualization and manipulation of medical device operating parameters 12, 21, 24, 201, 203, 220 that influence image quality by providing a touchscreen device 140, 200 that facilitates synchronous manipulation of interdependent medical device operating parameters 12, 21, 24, 201, 203, 220. In accordance with various embodiments, a method 300 may comprise displaying 302, at a display system 150, medical image data as the medical image data is acquired by a medical imaging modality 110. The medical image data is acquired based on operating parameters 12, 21, 24, 201, 203, 220, each of the operating parameters comprising an associated value 202, 204, 222-226. The method 300 may comprise receiving 304 a selection to adjust the associated value of one of the operating parameters 12, 21, 24, 201, 203, 220. The selected one of the operating parameters is a parameter in a pre-defined set of operating parameters 12, 21, 24, 201, 203, 220. The method 300 may comprise presenting 308, via a touchscreen user input module 140, an operating parameter user interface 200 comprising the pre-defined set of operating parameters 201, 203, 220. The method 300 may comprise receiving 310, at the operating parameter user interface 200, a touch user input via the touchscreen user input module 140 that synchronously sets the associated value 202, 204, 222-226 of each of a plurality of the operating parameters in the pre-defined set of operating parameters 201, 203, 220. The method 300 may comprise instantaneously 312 updating the displaying the medical image data as the associated value 202, 204, 222-226 of each of the plurality of operating parameters in the pre-defined set of operating parameters 201, 203, 220 is synchronously set in response to the receiving the touch user input.

In various embodiments, the method 300 may comprise continuously acquiring 302, by the medical imaging modality 110, the medical image data based on the operating parameters 12, 21, 24, 201, 203, 220 during an examination. In certain embodiments, the method 300 may comprise storing 310, at storage 130, the associated value 202, 204, 222-226 of each of the plurality of the operating parameters in the pre-defined set of operating parameters 12, 21, 24, 201, 203, 220 synchronously set in response to the touch user input. In a representative embodiment, the method 300 comprises determining 306, by the processor 120, whether the selected one of the operating parameters is a parameter in a pre-defined set of operating parameters 12, 21, 24, 201, 203, 220.

In certain embodiments, the touch user input is a multi-touch input. In a representative embodiment, the pre-defined set of operating parameters 12, 21, 24, 201, 203, 220 comprises 3 operating parameters. In various embodiments, the operating parameter user interface 200 comprises a grid 210. Each point in the grid 210 corresponds with the associated value 202, 204 of each of the plurality of operating parameters 201, 203 in the pre-defined set of operating parameters 201, 203. In certain embodiments, the method 300 comprises activating an automatic selection mode 310. The associated value 202, 204 of one of the plurality of operating parameters in the pre-defined set of operating parameters 201, 203 is automatically selected based on a selection of the associated value 202, 204 of another of the plurality of operating parameters 201, 203 in the pre-defined set of operating parameters 201, 203. In a representative embodiment, the associated value 202, 204, 222-226 of each of the plurality of the operating parameters in the pre-defined set of operating parameters 201, 203, 220 is dynamically determined based on the touch user input.

In accordance with various embodiments, a system 100 may comprise a display system 150, a touchscreen user input module 140, and a processor 120. The display system 150 may be operable to display medical image data as the medical image data is acquired. The medical image data may be acquired based on operating parameters 12, 21, 24, 201, 203, 220 and each of the operating parameters may have an associated value 202, 204, 222-226. The touchscreen user input module 140 may be operable to present an operating parameter user interface 200 comprising a pre-defined set of operating parameters 201, 203, 220 in response to a received selection to adjust the associated value of one of the operating parameters. The selected one of the operating parameters is a parameter in the pre-defined set of operating parameters 12, 21, 24, 201, 203, 220. The touchscreen user input module 140 may be operable to receive a touch user input corresponding with the operating parameter user interface 200 that synchronously sets the associated value of each of a plurality of the operating parameters in the pre-defined set of operating parameters 201, 203, 220. The processor 120 may be configured to instantaneously update the display of the medical image data as an associated value 202, 204, 222-226 of each of a plurality of operating parameters in a pre-defined set of operating parameters 201, 203, 220 is synchronously set.

In certain embodiments, the system 100 may comprise a medical imaging modality 110 configured to continuously acquire the medical image data based on the operating parameters 12, 21, 24, 201, 203, 220 during an examination. In a representative embodiment, the system 100 may comprise a storage 130 configured to store the associated value 202, 204, 222-226 of each of the plurality of the operating parameters in the pre-defined set of operating parameters 12, 21, 24, 201, 203, 220 synchronously set in response to the touch user input. In various embodiments, the processor 120 is configured to determine whether the selected one of the operating parameters is a parameter in a pre-defined set of operating parameters 12, 21, 24, 201, 203, 220.

In a representative embodiment, the touchscreen user input module 140 comprises multi-touch input functionality. In various embodiments, the pre-defined set of operating parameters 12, 21, 24, 201, 203, 220 comprises 3 operating parameters. In certain embodiments, the operating parameter user interface 200 comprises a grid 210. Each point in the grid 210 may correspond with the associated value 202, 204 of each of the plurality of operating parameters 201, 203 in the pre-defined set of operating parameters 201, 203. In a representative embodiment, the touchscreen user input module 140 is operable to receive a selection activating an automatic selection mode. The associated value 202, 204 of one of the plurality of operating parameters in the pre-defined set of operating parameters 201, 203 is automatically selected based on a selection of the associated value 202, 204 of another of the plurality of operating parameters 201, 203 in the pre-defined set of operating parameters 201, 203. In various embodiments, the associated value 202, 204, 222-226 of each of the plurality of the operating parameters in the pre-defined set of operating parameters 201, 203, 220 is dynamically determined based on the touch user input.

Certain embodiments provide a non-transitory computer readable medium having stored computer program comprises at least one code section that is executable by a machine for causing the machine to perform steps 300 disclosed herein. Exemplary steps 300 may comprise displaying 302 medical image data as the medical image data is acquired according to operating parameters 12, 21, 24, 201, 203, 220, each of the operating parameters comprising an associated value 202, 204, 222-226. The steps 300 may comprise receiving 304 a selection to adjust the associated value of one of the operating parameters. The selected one of the operating parameters may be a parameter in a pre-defined set of operating parameters 12, 21, 24, 201, 203, 220. The steps 300 may comprise presenting 308 an operating parameter user interface 200 at a touchscreen user input module 140. The operating parameter user interface 200 may comprise the pre-defined set of operating parameters 201, 203, 220. The steps 300 may comprise processing 310 a received touch user input corresponding with the operating parameter user interface 200 to synchronously set the associated value 202, 204, 222-226 of each of a plurality of the operating parameters in the pre-defined set of operating parameters 201, 203, 220. The steps 300 may comprise instantaneously updating 312 the displaying the medical image data as the associated value 202, 204, 222-226 of each of the plurality of operating parameters in the pre-defined set of operating parameters 201, 203, 220 is synchronously set in response to the processing the received touch user input.

In various embodiments, the operating parameter user interface 200 comprises a grid 210. Each point in the grid 210 corresponds with the associated value 202, 204 of each of the plurality of operating parameters 201, 203 in the pre-defined set of operating parameters 201, 203.

As utilized herein the term “circuitry” refers to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Other embodiments may provide a computer readable device and/or a non-transitory computer readable medium, and/or a machine readable device and/or a non-transitory machine readable medium, having stored thereon, a machine code and/or a computer program having at least one code section executable by a machine and/or a computer, thereby causing the machine and/or computer to perform the steps as described herein for enhancing visualization and manipulation of medical device operating parameters that influence image quality by providing a touchscreen device that facilitates synchronous manipulation of interdependent medical device operating parameters.

Accordingly, certain embodiments may be realized in hardware, software, or a combination of hardware and software. Various embodiments may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

Various embodiments may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method, comprising:
displaying, at a display system, medical image data as the medical image data is acquired by a medical imaging modality, wherein the medical image data is acquired based on operating parameters, each of the operating parameters comprising an associated value;
receiving a selection to adjust the associated value of one of the operating parameters, wherein the selected one of the operating parameters is a parameter in a pre-defined set of operating parameters;
presenting, via a touchscreen user input module, an operating parameter user interface comprising the pre-defined set of operating parameters;
receiving, at the operating parameter user interface, a touch user input via the touchscreen user input module that synchronously sets the associated value of each of a plurality of the operating parameters in the pre-defined set of operating parameters; and
instantaneously updating the displaying the medical image data as the associated value of each of the plurality of operating parameters in the pre-defined set of operating parameters is synchronously set in response to the receiving the touch user input.

2. The method according to claim 1, comprising continuously acquiring, by the medical imaging modality, the medical image data based on the operating parameters during an examination.

3. The method according to claim 1, comprising storing, at storage, the associated value of each of the plurality of the operating parameters in the pre-defined set of operating parameters synchronously set in response to the touch user input.

4. The method according to claim 1, comprising determining, by the processor, whether the selected one of the operating parameters is a parameter in a pre-defined set of operating parameters.

5. The method according to claim 1, wherein the touch user input is a multi-touch input.

6. The method according to claim 5, wherein the pre-defined set of operating parameters comprises 3 operating parameters.

7. The method according to claim 1, wherein the operating parameter user interface comprises a grid, wherein each point in the grid corresponds with the associated value of each of the plurality of operating parameters in the pre-defined set of operating parameters.

8. The method according to claim 1, comprising activating an automatic selection mode, wherein the associated value of one of the plurality of operating parameters in the pre-defined set of operating parameters is automatically selected based on a selection of the associated value of another of the plurality of operating parameters in the pre-defined set of operating parameters.

9. The method according to claim 1, wherein the associated value of each of the plurality of the operating parameters in the pre-defined set of operating parameters is dynamically determined based on the touch user input.

10. A system, comprising:
a display system operable to display medical image data as the medical image data is acquired, wherein the medical image data is acquired based on operating parameters, each of the operating parameters comprising an associated value;
a touchscreen user input module operable to:
present an operating parameter user interface comprising a pre-defined set of operating parameters in response to a received selection to adjust the associated value of one of the operating parameters, wherein the selected one of the operating parameters is a parameter in the pre-defined set of operating parameters, and
receive a touch user input corresponding with the operating parameter user interface that synchronously sets the associated value of each of a plurality of the operating parameters in the pre-defined set of operating parameters; and
a processor configured to instantaneously update the display of the medical image data as an associated value of each of a plurality of operating parameters in a pre-defined set of operating parameters is synchronously set.

11. The system according to claim 10, comprising a medical imaging modality configured to continuously acquire the medical image data based on the operating parameters during an examination.

12. The system according to claim 10, comprising a storage configured to store the associated value of each of the plurality of the operating parameters in the pre-defined set of operating parameters synchronously set in response to the touch user input.

13. The system according to claim 10, wherein the processor is configured to determine whether the selected one of the operating parameters is a parameter in a pre-defined set of operating parameters.

14. The system according to claim 10, wherein the touchscreen user input module comprises multi-touch input functionality.

15. The system according to claim 14, wherein the pre-defined set of operating parameters comprises 3 operating parameters.

16. The system according to claim 10, wherein the operating parameter user interface comprises a grid, wherein each point in the grid corresponds with the associated value of each of the plurality of operating parameters in the pre-defined set of operating parameters.

17. The system according to claim 10, wherein the touchscreen user input module is operable to receive a selection activating an automatic selection mode, wherein the associated value of one of the plurality of operating parameters in the pre-defined set of operating parameters is automatically selected based on a selection of the associated value of another of the plurality of operating parameters in the pre-defined set of operating parameters.

18. The system according to claim 10, wherein the associated value of each of the plurality of the operating parameters in the pre-defined set of operating parameters is dynamically determined based on the touch user input.

19. A non-transitory computer readable medium having stored thereon, a computer program having at least one code section, the at least one code section being executable by a machine for causing the machine to perform steps comprising:
displaying medical image data as the medical image data is acquired according to operating parameters, each of the operating parameters comprising an associated value;
receiving a selection to adjust the associated value of one of the operating parameters, wherein the selected one of the operating parameters is a parameter in a pre-defined set of operating parameters;
presenting an operating parameter user interface at a touchscreen user input module, the operating parameter user interface comprising the pre-defined set of operating parameters;
processing a received touch user input corresponding with the operating parameter user interface to synchronously set the associated value of each of a plurality of the operating parameters in the pre-defined set of operating parameters; and
instantaneously updating the displaying the medical image data as the associated value of each of the plurality of operating parameters in the pre-defined set of operating parameters is synchronously set in response to the processing the received touch user input.

20. The non-transitory computer readable medium according to claim 19, wherein the operating parameter user interface comprises a grid, wherein each point in the grid corresponds with the associated value of each of the plurality of operating parameters in the pre-defined set of operating parameters.
